(19) United States
(12) Patent Application Publication
(10) Pub. No.: US 2011/0192392 A1
(43) Pub. Date: Aug. 11, 2011

(54) Foldable Grill

(76) Inventors: Jan-Nan Chen, Taichung (TW); Tammy Yen, Taichung (TW)

(21) Appl. No.: 12/963,721

(22) Filed: Dec. 9, 2010

(30) Foreign Application Priority Data
Feb. 6, 2010 (TW) 99103669

(51) Int. Cl. A47J 37/00

(52) U.S. Cl. 126/25 R

(57) ABSTRACT

A grill includes two shells, a sidewall, two support legs, and a stand. The shells are pivotally joined together and are pivotal relative to each other between an open position and a closed position. The sidewall is adapted to be disposed between the shells to keep the two shells disposed in the open position. The support legs pivotally join to the two shells, respectively. The stand includes two stand members pivotally joined together and abuts against a support surface when the support surface bears the grill. The stand members are pivotal with respect to each other in response to the two shells disposed between the open position and the closed position. The support legs are pivotal to a supporting-mode position where the grill is prevented from being knocked down, and are pivotal to a carrying-mode position where the support legs are grasped as a handle to carry the grill.

### BACKGROUND OF THE INVENTION

1. Field of the Invention

The present invention relates to a grill and, in particular, to a grill that is foldable in a quick manner and is conveniently portable.

2. Description of the Related Art

TW Patent No. 357598 shows a grill that is portable and is foldable. The grill includes two shells pivotally joined together. The shells are movable between open and closed positions. The grill further includes two sidewalls releasably mounted between the shells. Specifically, the sidewalls are erected between the shells when the shells are in the open position and are dismounted when the shells are in the closed position, respectively. The grill yet further includes two foot connecting members fixedly disposed on the two shells, respectively, and two supporting legs are released joined to two distal ends of each foot connecting member in order to uphold the shells stably. Specifically, the support legs are erected when the two shells are in the open position. However, it is troublesome to erect the support legs every time after the support legs are dismounted from the grill to allow the user to transport the grill easily and to save storage space. Also, the support legs are liable to get lost or mislaid after they are detached from the grill or during transportation. Additionally, the shells are raised too high from a support surface that bears the grill by the support legs and it is too easy to tip over the grill inadvertently.

The present invention is, therefore, intended to obviate or at least alleviate the problems encountered in the prior art.

### SUMMARY OF THE INVENTION

According to the present invention, a grill includes two shells, a sidewall, two support legs, and a stand. The two shells are pivotally joined together and are pivotal relative to each other between an open position and a closed position. The sidewall is movable between an erected position and a stowed position, and is in the erected position to keep the two shells disposed in the open position, and in addition, is in the stowed position when the two shells are in the closed position. The two support legs pivotally join to the two shells, respectively. The stand includes two stand members pivotally joined together and abuts against a support surface when the support surface bears the grill. The stand members are pivotal with respect to each other between a first relative position and a second relative position in response to the two shells disposed between the open position and the closed position.

The two support legs are pivotal to a supporting-mode position where the grill where the grill is prevented from being knocked down, with one supporting leg abutting against the supporting surface to prevent the grill from being tilted clockwise, with the other supporting leg abutting against the supporting surface to prevent the grill from being tilted counterclockwise. Furthermore, the two support legs are pivotal to a carrying-mode position where the support legs are grasped as a handle to carry the grill.

The two support legs are fixed and restrained from being pivoted when in the supporting-mode position.

It is an object of the present invention to provide a grill that is foldable in a quick manner.

It is another object of the present invention to provide a grill that and is conveniently portable.

It is yet another object of the present invention to provide a bike that has a simple structure and is safe to use.

Other objects, advantages, and new features of the present invention will become apparent from the following detailed description of the invention when considered in conjunction with the accompanied drawings.

### BRIEF DESCRIPTION OF THE DRAWINGS

FIG. 1 is a perspective view of a grill in accordance with a first embodiment of the present invention and show the grill in an extended position.

FIG. 2 is another perspective view of the grill of FIG. 1 and shows the grill in a collapsed position.

FIG. 3 is a partial, exploded perspective view of the grill of FIG. 1 and illustrates a cooking grate, a charcoal-supporting member, and an ash collector, and organization thereof.

FIG. 4 is an extended perspective view of FIG. 3 and shows the cooking grate, charcoal-supporting member and ash controller in a stack-up position.

FIG. 5 is a side view of the grill of FIG. 1.

FIG. 6 is a partial, exploded perspective view of the grill of FIG. 1.

FIG. 7 is a partial, enlarged view of FIG. 6.

FIG. 8 is a cross-sectional view taken along line 8-8 in FIG. 1.

FIG. 9 is a cross-sectional view taken along line 9-9 in FIG. 5.

FIG. 10 shows the grill of FIG. 1 in an intermediate step of the procedure of transforming the grill from the extended position to the collapsed position thereof.

FIG. 11 shows the grill of FIG. 1 in an intermediate step of the procedure of transforming the grill from the extended position to the collapsed position thereof, which follows after the step of FIG. 10.

FIG. 12 illustrates the grill of FIG. 1 in an intermediate step of the procedure of transforming the grill from the extended position to the collapsed position thereof, which follows after the step of FIG. 11.

FIG. 13 illustrates the grill of FIG. 1 in an intermediate step of the procedure of transforming the grill from the extended position to the collapsed position thereof, which follows after the step of FIG. 12.

FIG. 14 is a side view showing the grill of FIG. 1 in the collapsed position thereof.

FIG. 15 is a cross-sectional view of FIG. 14.

FIG. 16 is a partial, enlarged view of FIG. 15.

FIG. 17 is a continued cross-sectional view of FIG. 16.

FIG. 18 is a partial, exploded perspective view of a grill in accordance with a second embodiment of the present invention.

FIG. 19 is a partial, enlarged view of FIG. 18.

FIG. 20 is a cross-sectional view of the grill of FIG. 18.

FIG. 21 is a cross-sectional view taken along line 21-21 of FIG. 20.

### DETAILED DESCRIPTION OF THE PREFERRED EMBODIMENTS

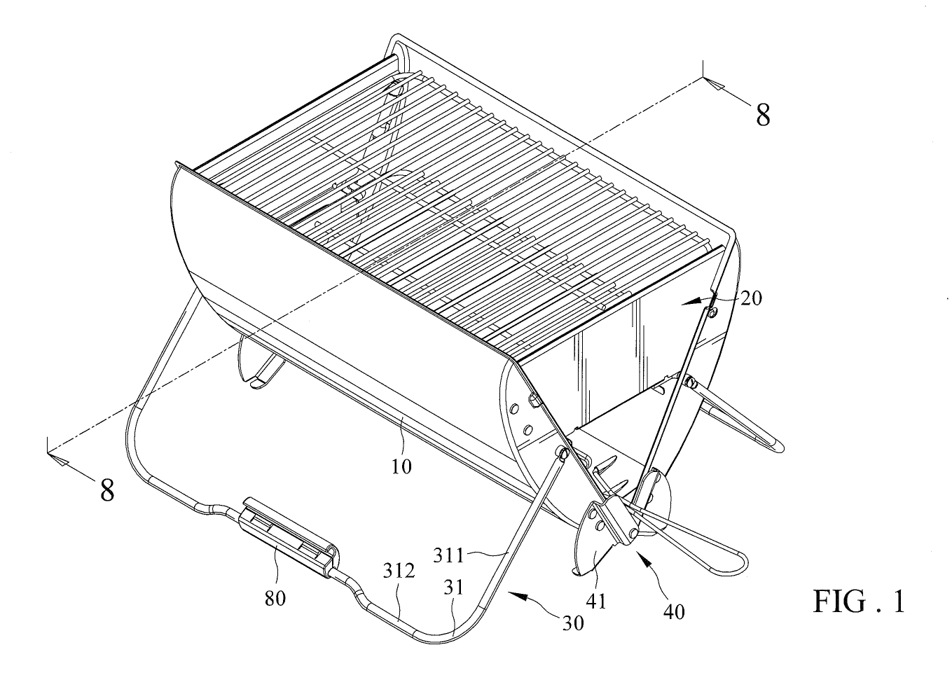

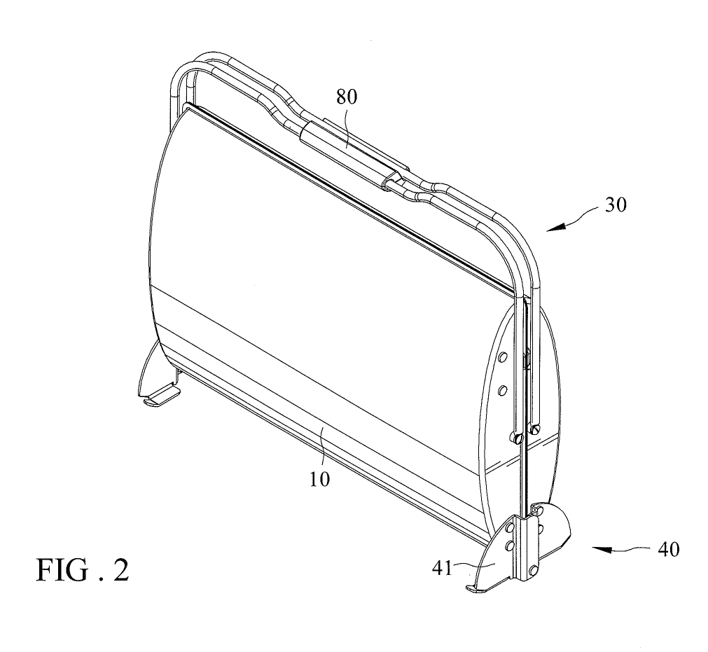

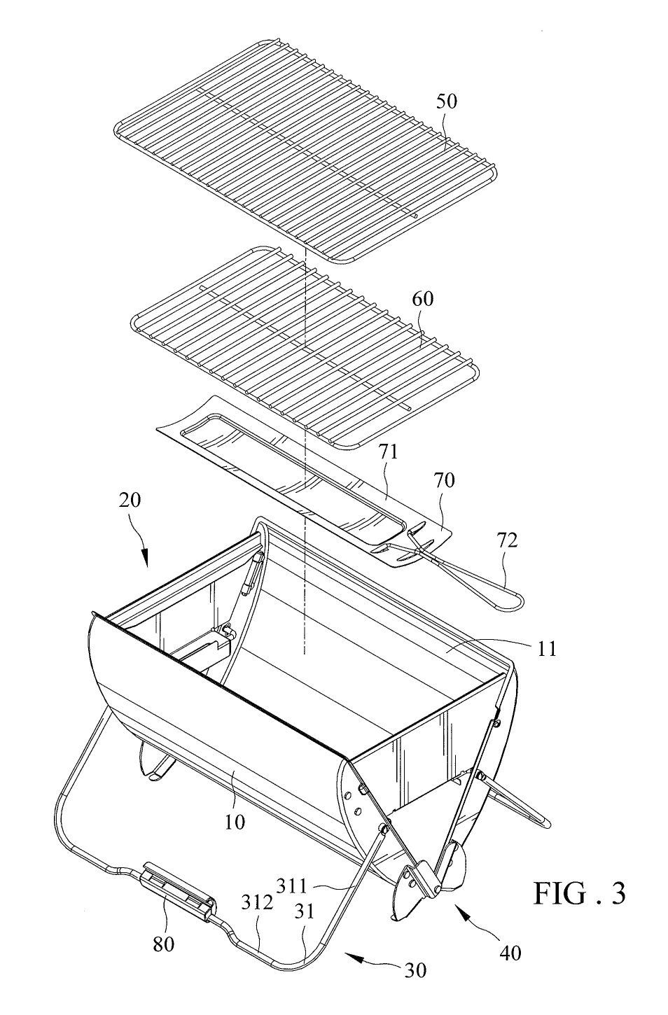

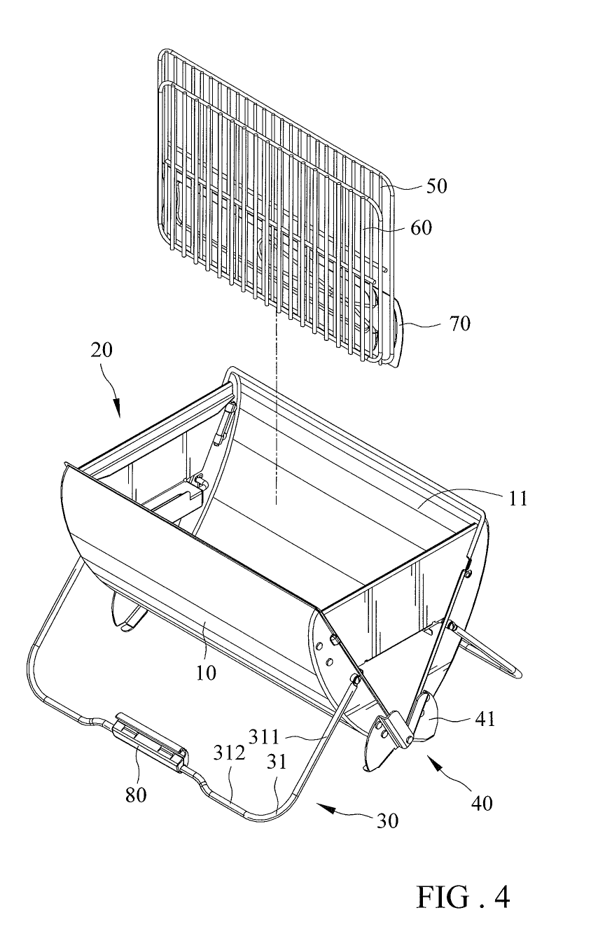

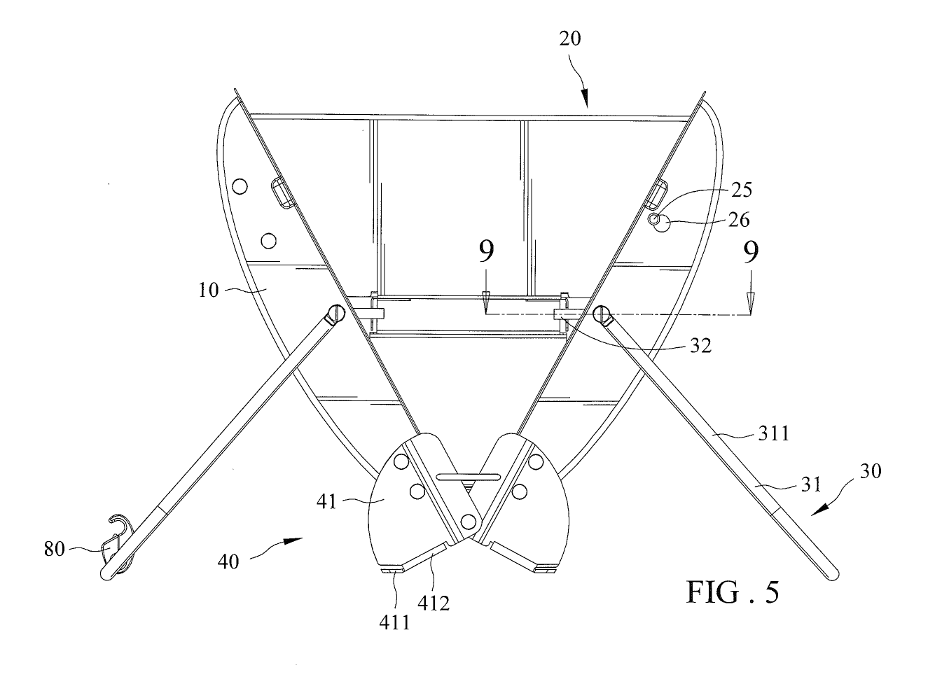

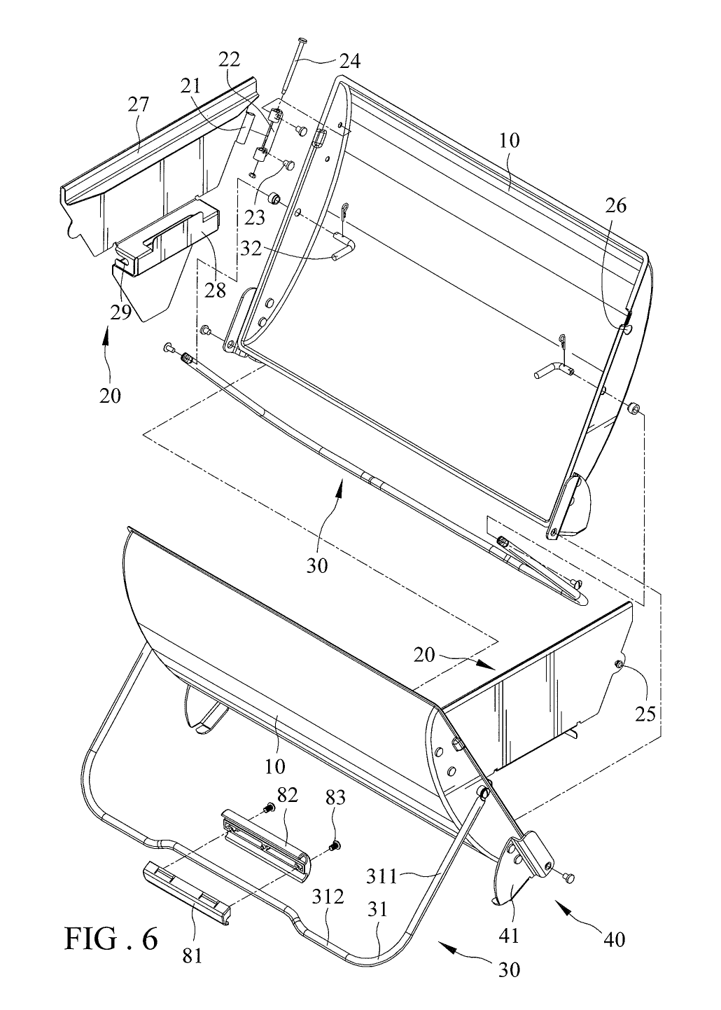

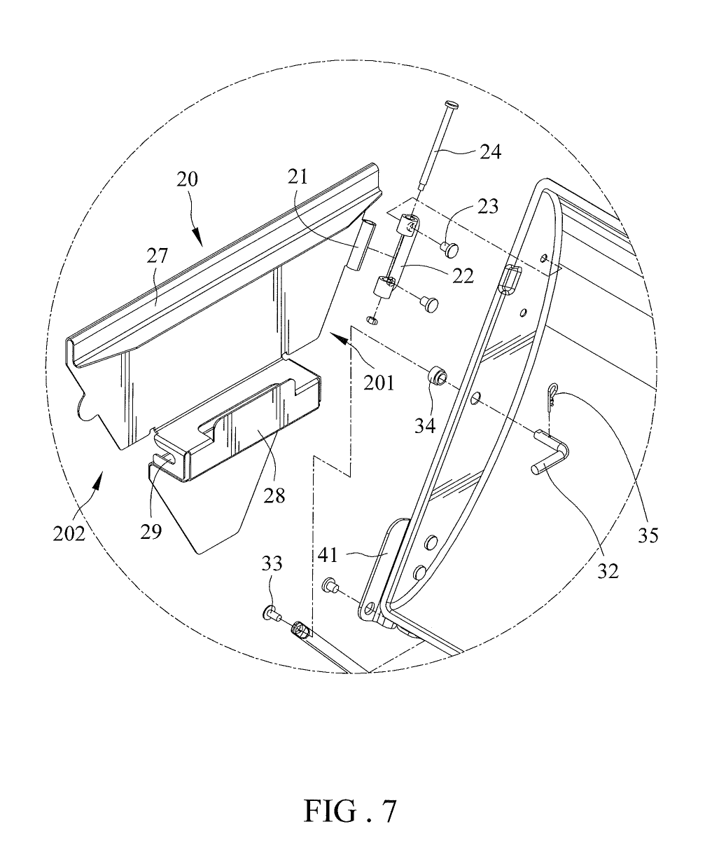

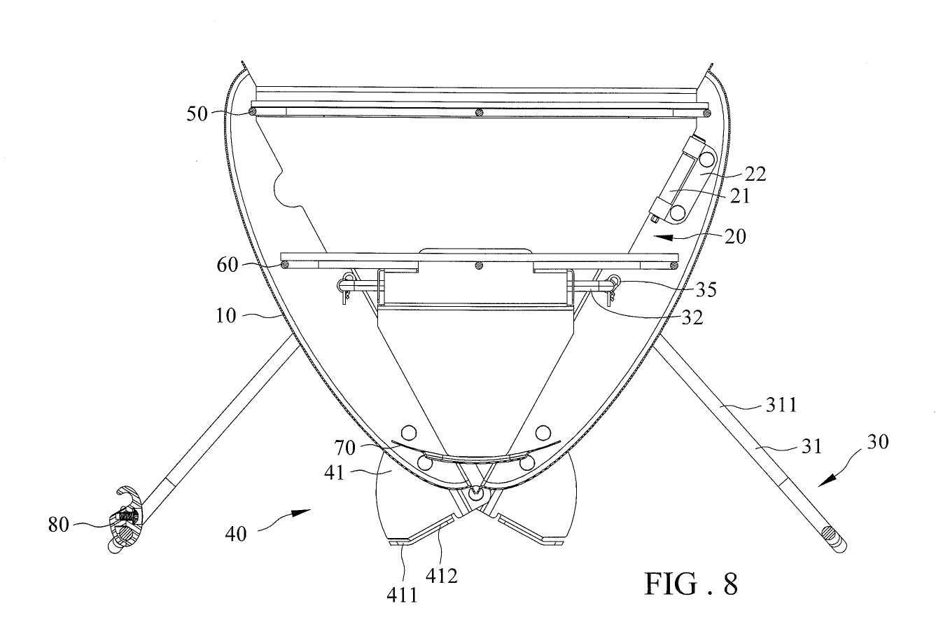

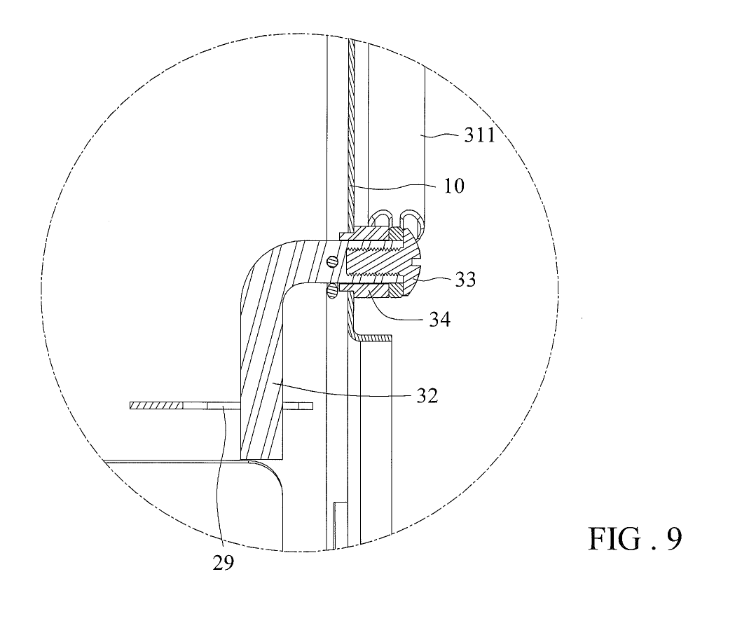

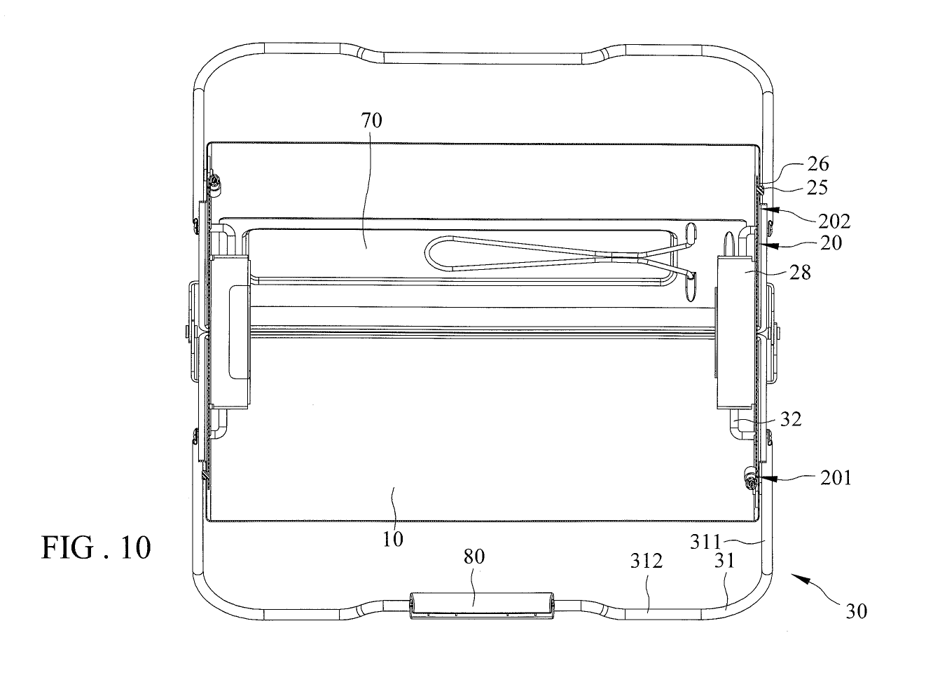

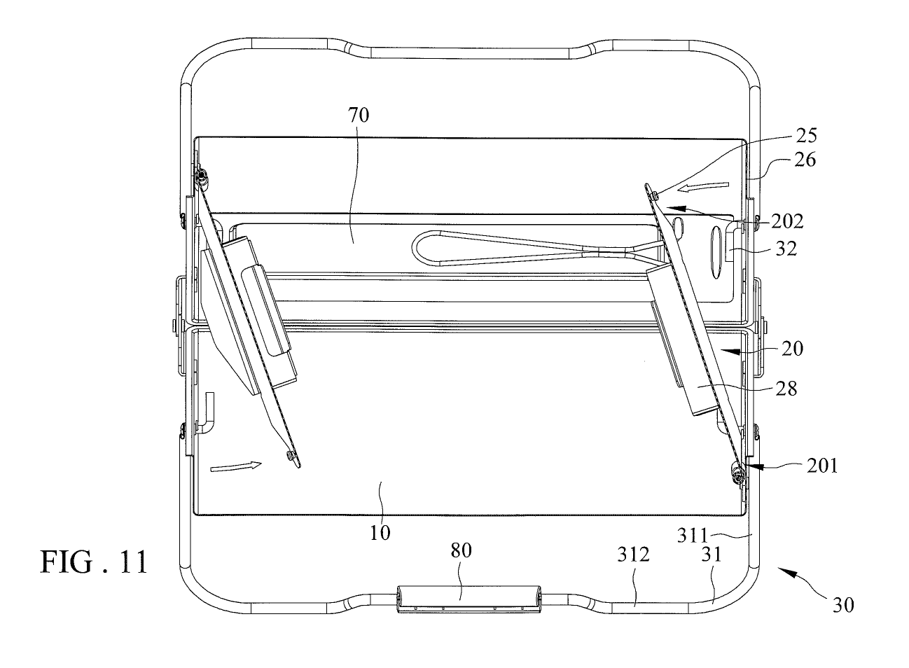

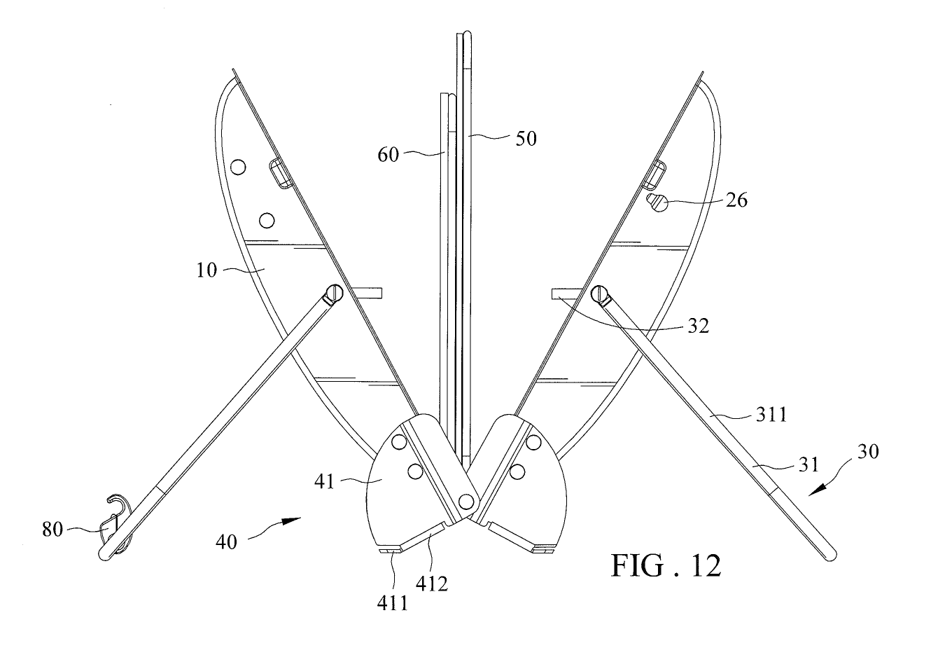

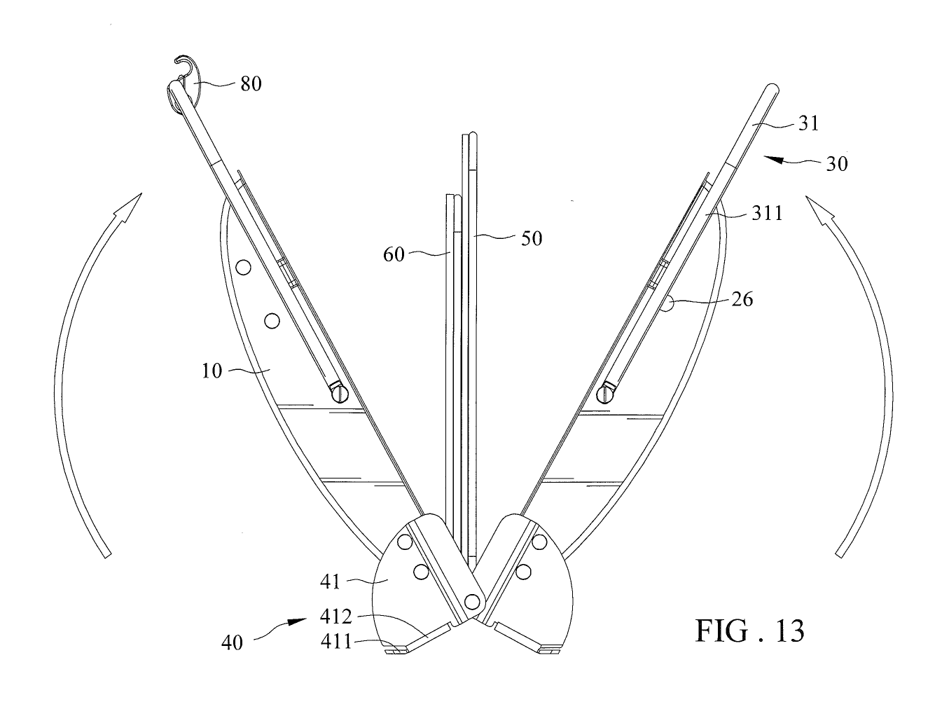

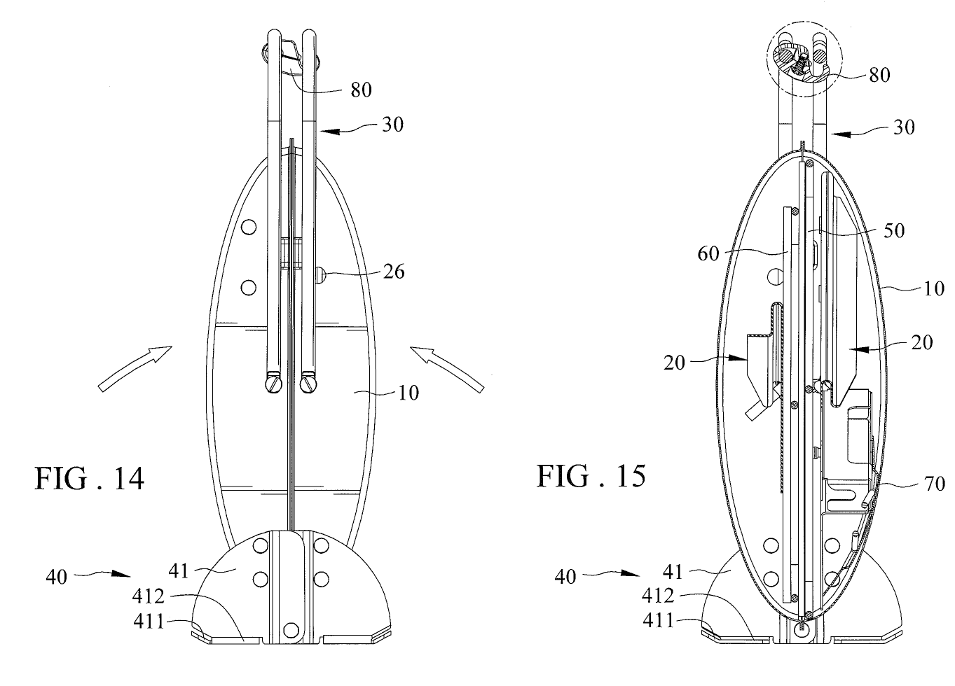

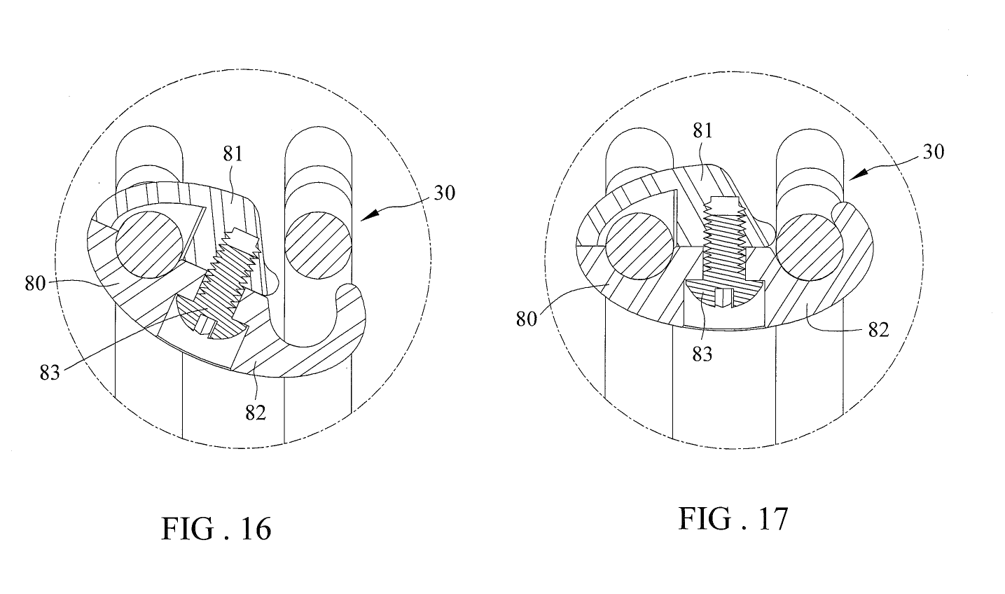

FIGS. 1 through 17 show a grill in accordance with a first embodiment of the present invention. The grill includes two shells 10, two sidewalls 20, and two support legs 30. The two shells 10 are joined together pivotally and are pivotal relative to each other between an open position and a closed position. Further, a chamber 11 is delimited by the two shells 10, and is exposed to outside when the two shells 10 are in the open position, and in addition, is enclosed when the two shells 10 are in a closed position. Each sidewall 20 is movable between an erected position and a stowed position within the shells 10, and is disposed in the erected position to keep the shells 10 disposed in the open position, and in addition, is disposed in the stowed position when the shells 10 are disposed in the closed position. Furthermore, each sidewall 20 extends from one of the two shells 10 to the other of the two shells 10 and includes a first distal end 201 joined to one of the two shells 10 and a second distal end 202 joined to the other of the two shells 10 when in the erected position. In the preferred embodiment, the first and second distal ends 201 and 202 of each sidewall 20 is joined to one of the two shells 10 pivotally and is releasably retained to the other of the two shells 10, respectively, that is, each sidewall 20 includes a connecting section 21 defined on the first distal end 201 thereof and each shell 10 includes a joint 22 fixed thereto by at least one fastener 23 and a pivot 24 is inserted through the connecting section 21 of one sidewall 20 and the joint 22 on the one shell 10 to connect the one sidewall 20 to the one shell 10 pivotally, and each sidewall 20 includes a locking member 25 defined on the second distal end 202 thereof and each shell 10 includes a holding section 26 defined thereon receiving the locking member 25 of one sidewall 20 to enable the second distal end 202 thereof to be retained. In this regard, when each sidewalls 20 is disposed in the stowed position, the second end 202 thereof is disengaged from the shell 10 it joins to and each sidewall 20 is pivoted to a position such that the second end 202 thereof is adjacent to the shell 10 to which the first end 201 thereof is pivotally joined, and in addition, when each sidewall 20 is disposed in the erected position, the two sidewalls 20 are cooperated to bear a cooking grate 50 on which food to be cooked is positioned and a charcoal-supporting member 60 on which charcoal(s) are positioned, that is, each sidewall 20 includes a first supporting edge 27 for bearing and restraining the cooking grate 50, and a second supporting edge 28 for bearing and restraining the charcoal-supporting member 60 beneath the cooking grate 50. Further, an ash collector 70 is adapted to be supported under the charcoal-supporting member 60 by the two shells 10 to collect ash produced from the charcoal(s). In the preferred embodiment, the ash collector 70 includes a platform 71 for receiving ash and a handle 72 the user grasps in order to transport the ash collector 70. Furthermore, the handle 72 is movable with respect to the platform 71 between an extended position during the transportation thereof and a stowed position. The two support legs 30 are pivotally joined to the two shells 10, respectively, and are pivotal between a supporting-mode position to enable the grill to stand stably on a support surface and to prevent the grill from being knocked down in that one supporting leg 30 abuts against the supporting surface to prevent the grill from being tilted clockwise while the other supporting leg abuts against the supporting surface to prevent the grill from being tilted counterclockwise, and in addition, a carrying-mode position to allow the user to hold as a handle to carry the grill. Specifically, each support leg 30 includes a first leg member 31 and two second leg members 32 fixedly joined to two ends of the first leg member 31, respectively, and the grill is adapted to be supported by each support leg 30 by the first leg member 31 thereof, and in addition, the two second leg members 32 of each support leg 30 are pivotally mounted on one of the two shells 10, thereby the first leg member 31 of each support leg 30 is pivotally joined to one of the two shells 10. More specifically, the first leg member 31 of each support leg 30 includes two first extensions 311 extending separately and a second extension 312 extending between and interconnecting with the two first extensions 311, and the two second leg members 32 and the first leg member 31 of each support leg 30 are joined together by joining the two second leg members 32 to the two first extensions 311 of the first leg member 31, respectively. In the preferred embodiment, the two second leg members 32 and the first leg member 31 of each support leg 30 are joined together with two fasteners 33, respectively, and each fastener 33 is inserted in one of the two first extensions 311 of the first member 31 and joins to one second leg member 32. Further, two spacers 34 are utilized and are retained in each shell 10. Further, two pegs 35 are utilized and are inserted through the two second leg members 32 of each support leg 30, respectively, and each shell 10 has a peripheral wall restraining one of the two pegs 35 to prevent the support leg 30 that connects thereto from disengagement therefrom.

Furthermore, in order to retain the support legs 30 in the supporting-mode position, the two second leg members 32 of each support leg 30 are engaged with the two sidewalls 20, respectively, and the two sidewalls 20 are disposed in the erected position. Specifically, each sidewall 20 includes a retaining section 29 defined thereon retaining one of the two second leg members 32 of each support leg 30. In the preferred embodiment, the retaining section 29 and the second supporting edge 28 of each sidewall 20 are associated with each other in that the retaining section 29 is defined in the second supporting edge 28, and in addition, the retaining section 29 is in the form of a slot. In this regard, each support leg 30 is retained in the supporting-mode position in that the two second leg members 32 thereof are engaged in the two slot-shaped retaining sections 29 in the two respective sidewalls 20, respectively, and in order to move each support leg 30 to another pivotal position, such as the carrying-mode position thereof, the two second leg members 32 thereof are disengaged from the two respective retaining sections 29. Moreover, the two second leg members 32 of each support leg 30 are disengaged from the two sidewalls 20, respectively, when each support leg 30 is disposed in the carrying-mode position, and in addition, after the two support legs 30 are disengaged from the sidewalls 20, each sidewall 20 is adapted to be disposed in the stowed position and the shells 10 are adapted to be disposed in the closed position. Further, a latch 80 is utilized to latch together the two support legs 30 that are disposed in the carrying-mode position so that the two support legs 30 are retained in the carrying-mode position. In the preferred embodiment, the latch 80 is mounted on one of the two support legs 30, i.e., on the second extension 312 of the first leg member 31, and includes a first latch member 81 and a second latch member 82 coupled together by a fastening member 83, and in addition, the second latch member 82 includes an end in the form of a hook for clutching the second extension 312 of the first leg member 31 of the other of the two support legs 30.

Moreover, the grill includes at least one stand 40 including two stand members 41 and one of the two stand members 41 is fixedly joined to one of the two shells 10 and the other of the two stand members 41 is fixedly joined to the other of the two shells 10, respectively, and in addition, the two stand members 41 are pivotally joined together and are pivotal with respect to each other between a first relative position and a second relative position in response to the two shells 10 disposed between the open position and the closed position, respectively. The at least one stand 40 is utilized to enable the grill to pose in an upright position on a support surface, and each stand member 41 includes a peripheral edge defining a first perimeter 411 and a second perimeter 412 extending from the first perimeter 411 and in a direction different to that of the first perimeter 411, and in addition, when the two stand members 41 are disposed in the first relative position and the two shells 10 are disposed in the open position the first perimeters 411 thereof are cooperated to abut against a support surface bearing the grill, and when the two stand members 41 are disposed in the second relative position and the shells 10 are disposed in the closed position the second perimeters 412 thereof are cooperated to abut against the support surface. In the preferred embodiment, two stands 40 are provided, thereby increasing the stability of the grill.

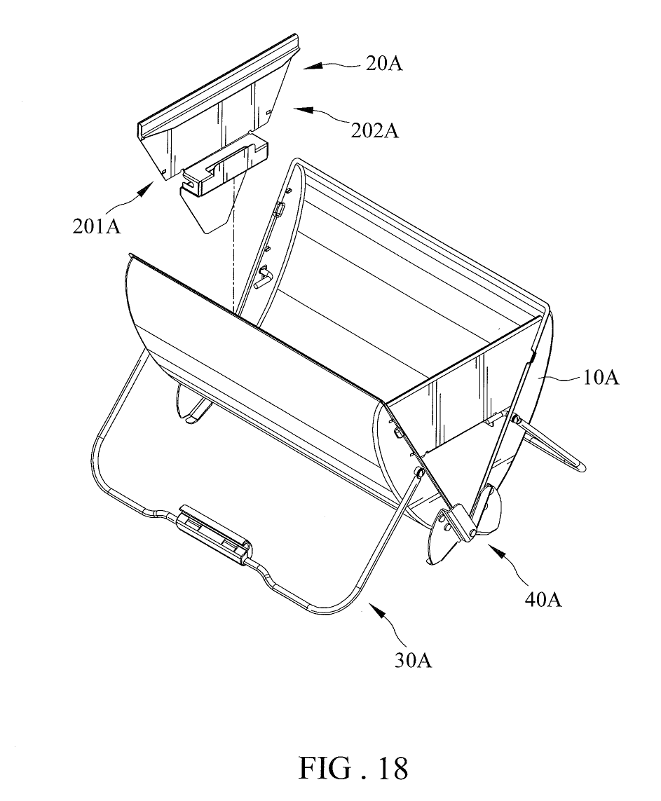

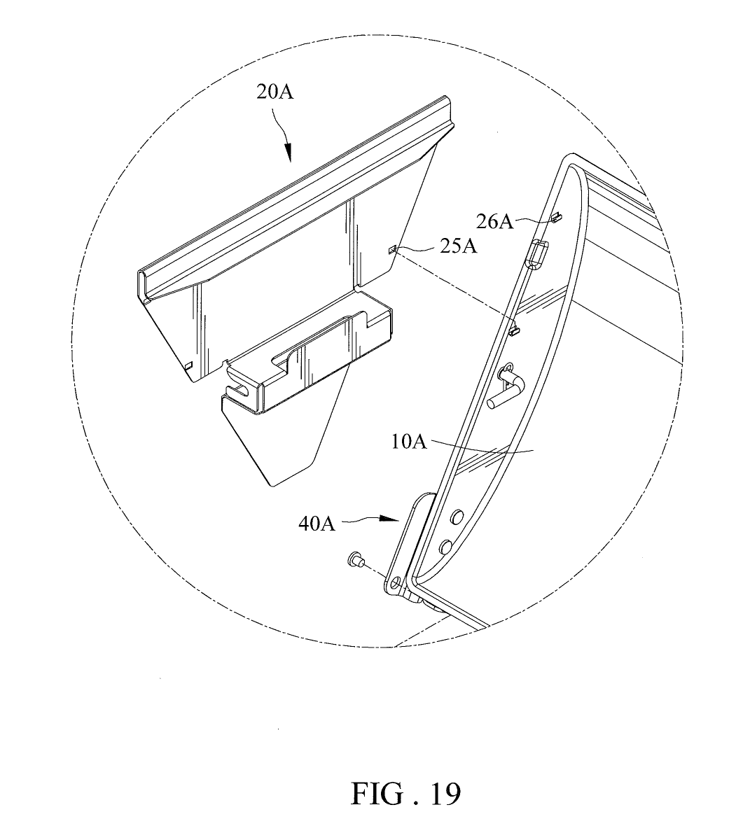

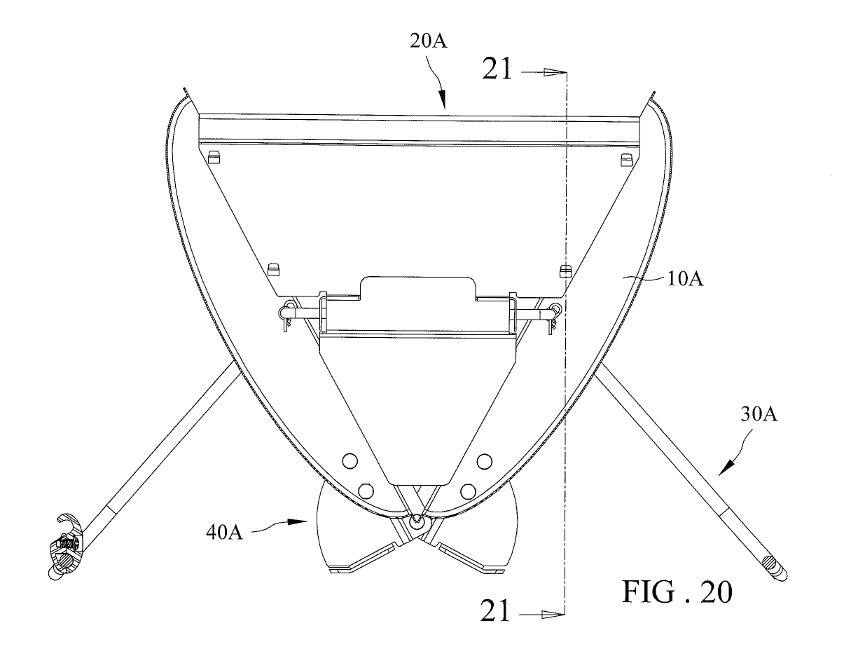

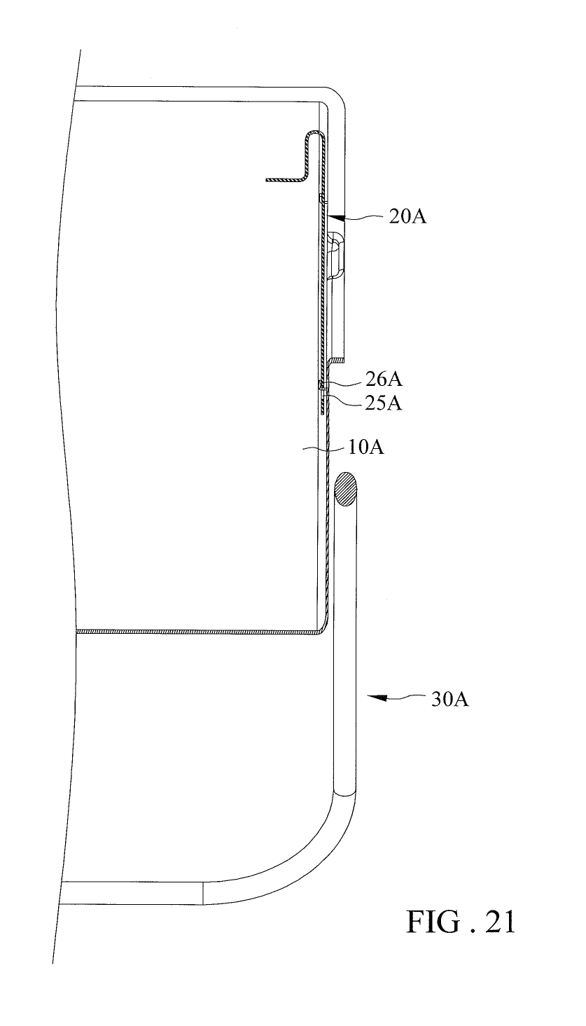

FIGS. 18 through 21 show a grill in accordance with a second embodiment of the present invention, wherein like numerals have been employed to denote like components of the previous embodiment, however, bearing the suffix “A”. The second embodiment differentiates from the first embodiment in that each sidewall 20A includes first and second distal ends 201A and 202A releasably retained to two shells 10A, respectively, that is, each sidewall 20A includes at least one locking member 25 defined on the first distal ends 201A thereof and at least one locking member 25A defined on the second distal ends 202A thereof, and each locking member 25A is in the form of a hole, and each shell 10A includes at least one holding section 26 engagable with the at least one locking member 25A.

In view of the forgoing, the grill is movable between an extended position where the shells 10 and 10A are in the open position and each sidewall 20 and 20A is in the erected position and the support legs 30 and 30A are in the supporting-mode position, and a collapsed position where the shells 10 and 10A are in the closed position and each sidewall 20 and 20A is in the stowed position to be encapsulated and restrained within the shells 10 and 10A and the support legs 30 and 30A are in the carrying-mode position.

While the specific embodiments have been illustrated and described, numerous modifications come to mind without significantly departing from the spirit of invention and the scope of invention is only limited by the scope of accompanying claims.

What is claimed is:

1. A grill comprising:
two shells pivotally joined together and pivotal relative to each other between an open position and a closed position;
a sidewall movable between an erected position and a stowed position, with the sidewall in the erected position to keep the two shells disposed in the open position, with the sidewall in the stowed position when the two shells are in the closed position;
two support legs pivotally joining to the two shells, respectively;
a stand including two stand members pivotally joined together and pivotal with respect to each other between a first relative position and a second relative position in response to the two shells disposed between the open position and the closed position; and
wherein the stand abuts against a support surface when the support surface bears the grill; and
wherein the two support legs are pivotal to a supporting-mode position where the grill is prevented from being knocked down, with one supporting leg abutting against the supporting surface to prevent the grill from being tilted clockwise, with the other supporting leg abutting against the supporting surface to prevent the grill from being tilted counterclockwise; and
wherein the two support legs are pivotal to a carrying-mode position where the support legs are grasped as a handle to carry the grill; and
wherein the two support legs are fixed and restrained from being pivoted when in the supporting-mode position.

2. The grill as claimed in claim 1, wherein the two support legs are releasably engaged with the sidewall to retain in the supporting-mode position, with engagement therebetween preventing each support leg from being pivoted, with the sidewall in the erected position.

3. The grill as claimed in claim 1, wherein the number of the sidewall is two, and wherein each support leg in the supporting-mode position includes two ends joined to one of the two sidewalls.

4. The grill as claimed in claim 3, wherein each support leg includes a first leg member including two first extensions extending separately and a second extension extending between and interconnecting with the two first extensions, two second leg members fixedly joined to the two first extensions respectively and pivotally mounted on one of the two shells, with the two second leg members releasably engaging with the two sidewalls respectively when the support legs are in the supporting-mode position.

5. The grill as claimed in claim 4, wherein each sidewall includes a retaining section defined thereon retaining one of the two second leg members of each support leg when the support legs are in the supporting-mode position.

6. The grill as claimed in claim 5, wherein the retaining section is in the form of a slot.

7. The grill as claimed in claim 1, wherein upon the sidewall in the erected position, the sidewall extends from one of the two shells to the other of the two shells and includes a first distal end joined to one of the two shells and a second distal end joined to the other of the two shells.

8. The grill as claimed in claim 7, wherein the first distal end of the sidewall is joined to one of the two shells pivotally.

9. The grill as claimed in claim 8, wherein upon the sidewall in the stowed position, the second distal end is releasably retained to the other of the two shells and is disengaged from the other of the two shells and is in a position adjacent to the one of the two shells when the sidewall.

10. The grill as claimed in claim 1, wherein the sidewall bears a cooking grate on which food to be cooked is positioned and a charcoal-supporting member on which charcoal(s) are positioned.

11. The grill as claimed in claim 10, further comprising an ash collector supported under the charcoal-supporting member by the two shells to collect ash produced from the charcoal(s).

12. The grill as claimed in claim 7, wherein upon the sidewall in the stowed position, the first distal end is disengaged from the one of the two shells.

13. The grill as claimed in claim 12, wherein upon the sidewall in the stowed position, the second distal end is disengaged from the other of the two shells.

14. The grill as claimed in claim 1, wherein each stand member includes a peripheral edge defining a first perimeter and a second perimeter extending from the first perimeter and in a direction different to that of the first perimeter, with the first perimeter abutting against the support surface when the two stand members are disposed in the first relative position and the two shells are disposed in the open position, with the second perimeter abutting against the support surface when the two stand members are disposed in the second relative position and the two shells are disposed in the closed position.

15. The grill as claimed in claim 1 further comprising a latch latching together the two support legs that are disposed in the carrying-mode position for retaining the two support legs in the carrying-mode position.
